(19) United States
(12) Patent Application Publication
(10) Pub. No.: US 2003/0217262 A1
(43) Pub. Date: Nov. 20, 2003

(54) Gateway, communication terminal equipment, and communication control program

(75) Inventors: Morihisa Kawai, Kawasaki (JP); Takeshi Saito, Kawasaki (JP); Teruhiko Onishi, Kawasaki (JP); Ikuo Takekawa, Kawasaki (JP); Satoru Chikuma, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited of, Kawasaki (JP)

(21) Appl. No.: 10/413,212

(22) Filed: Apr. 15, 2003

(30) Foreign Application Priority Data
Apr. 26, 2002 (JP) 2002-125261

(51) Int. Cl. H04L 9/00

(52) U.S. Cl. 713/153; 713/168

(57) ABSTRACT

A gateway, a communication terminal equipment, and a communication control program are provided for reducing the number of items to be specified by a user in association with the change of the gateway computer, thereby lessening the user's burden. At first, the gateway computer transmits a message for indicating securement of a security capability to the communication terminal equipment at regular intervals and in a broadcasting manner. Then, the communication terminal equipment obtains an address of the gateway computer having the security capability through a wireless network. Next, the communication terminal equipment communicates data with the gateway computer based on the obtained address and determines an authenticating system and an encrypting and a decrypting rules for data to be communicated. Then, the communication terminal equipment and the gateway computer are operated to communicate data according to the encrypting and the decrypting rules.

### BACKGROUND OF THE INVENTION

(1) Field of the Invention

The present invention relates to a gateway, a communication terminal equipment, and a communication control program that are arranged to control communications wirelessly, and more particularly to a gateway, a communication terminal equipment, and a communication control program that are arranged to control communications between a mobile communication terminal equipment for transferring data and a gateway provided with a security capability.

(2) Description of the Related Art

In recent days, the hardware vendors have successively shipped several kinds of mobile communication terminal equipments such as a note-sized PC (Personal Computer) and a PDA (Personal Digital Assistant) each of which includes a wireless communication interface like a wireless LAN (Local Area Network) built therein. Moreover, the latest product (including a set of access points and a PC card) has supported the protocols IEEE802.11a and IEEE802.11g arranged to speed up the conventional communication protocol, both of which are specified as the standard protocol of the wireless LAN. That is, the wireless communication technology is now on the way of reaching the infrastructure of the enterprise networks.

Under these circumstances, the introduction of the wireless communication technology into an enterprise network indispensably needs to secure the communication security. As one of the reasons, the WEP (Wired Equivalent Privacy), which is the mainstream of the security technology in the field of the wireless LAN communication, is being revealed to be vulnerable. A new solution to the security problem is now being expected. Further, unlike the conventional wired communication, the communication terminal equipment provided with a wireless communication interface is movable.

As means for keeping the security in introducing the wireless communication technology into an enterprise, therefore, it has been conventionally considered that a gateway computer for securing the communication security is installed between the wireless network and the wired one. Further, unlike a VPN (Virtual Private Network) between fire walls through the internet or between a fire wall and a client, if the communication terminal equipment is movable, it means that the communication terminal equipment is required to change the secure connection of the communication path to one gateway computer to another.

However, the conventional technology has required the user of the communication terminal equipment to newly set a communication environment and to manually reboot the system each time the connection of the communication path is changed from one gateway computer to another when the communication terminal equipment is moving. If the communication terminal equipment requires the user to do these settings, it means that the terminal equipment loses its essential value. Hereafter, these disadvantages will be concretely described.

(1) When the communication terminal equipment moves from one sub-network to another, the target address of the gateway computer is changed. In this case, the communication terminal equipment is required to update the address of the gateway computer for establishing a secure (safe) communication path. For this purpose, the user is also required to manually reboot the OS (Operating System) and specify the communication environment again

(2) In a case that the communication terminal equipment is off the service area of the gateway computer, since no means is provided for quickly detecting it, the user needs a considerably long time in performing a recovering process.

(3) In the communication terminal equipment having a plurality of communication interfaces mounted therein, no means is provided for determining if the target interface is valid or invalid. Hence, the user cannot select the proper interface to the current environment, and the communication suffers from an overhead. Moreover, for selecting a valid interface or establishing a secure communication path, the user is required to manually specify the communication environment.

### SUMMARY OF THE INVENTION

In view of the foregoing, it is an object of the present invention to provide a communication control method, a gateway, a communication terminal equipment, and a communication control program which are arranged to automatically specify a communication environment for and secure a communication path to each gateway computer as keeping the communication security.

To accompanying the object, according to the present invention, there is provided a communication control program for relaying data to be communicated between a wireless network and another network on the side of the gateway. This communication control program performs the following steps: periodically transmitting a message for indicating securement of a security capability on the wireless network in a broadcasting manner; communicating data with the communication terminal equipment in response to a request from the communication terminal equipment received the message, for determining an authenticating system and an encrypting and a decrypting rules of the data to be communicated; encrypting data destined for the communication terminal equipment according to the encrypting rule and transmitting the encrypted data through the wireless network; and decrypting the encrypted data received from the communication terminal equipment through the wireless network according to the decrypting rule.

Further, to accomplish the above object, the gateway is provided for relaying data to be communicated between the wireless network and another network. This gateway includes a connection check unit that broadcasts periodically a message for indicating that the wireless network secures a security capability; a communication path automatic establishing unit for communicating data with the communication terminal equipment in response to a request from the communication terminal equipment received the message, determining an authenticating system and an encrypting and a decrypting rules for the data to be communicated, and giving an authentication between the communication terminal equipment and the gateway itself according to the authenticating system; and an encrypting communication unit of encrypting data destined for the communication terminal equipment according to the encrypting rule, transmitting the encrypted data through the wireless network, and decrypting the encrypted data received from the communication terminal equipment through the wireless network according to the decrypting rule.

Further, to according to the above object, the communication terminal equipment is provided for communicating data through the wireless network. This communication terminal equipment includes a received data processing unit for obtaining an address of the gateway provided with the security capability through the wireless network when the terminal equipment itself enters into a communicable range serviced by the wireless network; a communication path automatic establishing unit of communicating data with the gateway on the basis of the obtained address, determining an authenticating system and an encrypting and a decrypting rules of the data to be communicated, and giving an authentication between the gateway and the terminal equipment itself according to the authenticating system; and an encrypting communication unit of encrypting data destined for another computer according to the encrypting rule, transmitting the encrypted data to the gateway through the wireless network, and decrypting the encrypted data received from the gateway through the wireless network according to the decrypting rule.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view according to the present invention;

FIG. 2 is a diagram showing a system structure to which an embodiment of the invention applies;

FIG. 3 is a function block diagram showing a communication terminal equipment according to an embodiment of the present invention;

FIG. 4 is a function block diagram showing a gateway computer according to an embodiment of the present invention;

FIG. 5 is a diagram showing a hardware arrangement of the communication terminal equipment and the gateway computer according to the embodiment of the present invention;

FIG. 6 is a view showing a protocol stack according to the embodiment of the present invention;

FIG. 7 is a diagram showing an example of communication devices mounted in the communication terminal equipment;

FIG. 8 is a table showing a priority sequence of the communication devices in the communication terminal equipment;

FIG. 9 is a view showing a structure of data to be stored in the communication terminal equipment;

FIG. 10 is a view showing a structure of data to be stored in the connected communication terminal equipment when a timer is counting;

FIG. 11 is a view showing a structure of data to be stored in the connected gateway computer;

FIG. 12 is a flowchart showing an overall operation of a communication control program according to an embodiment of the present invention;

FIG. 13 is a flowchart showing the overall operation of the communication control program shown in FIG. 12 in a case that the gateway computer is a default one;

FIG. 14 is a view showing a movement of the communication terminal equipment 10 to another sub-net in a LAN system to which the present embodiment applies;

FIG. 15 is a flowchart showing an overall operation to be executed in a case that the communication terminal equipment according to the embodiment of the present invention is moved;

FIG. 16 is a flowchart showing an overall operation to be executed in a case that the communication terminal equipment according to this embodiment of the present invention is moved and the gateway computer is a default one;

FIG. 17 is a view showing an operation to be executed in a case that the communication terminal equipment is moved out of a service area in the LAN system to which the present embodiment applies;

FIG. 18 is a flowchart showing an overall operation to be executed in a case that the communication terminal equipment according to the embodiment of the present invention is moved out of the service area; and

FIG. 19 is a flowchart showing a basic operation of a communication device selecting process to be executed in the embodiment of the present invention.

### DESCRIPTION OF THE PREFERRED EMBODIMENTS

Hereafter, the embodiment of the present invention will be described with reference to the appended drawings.

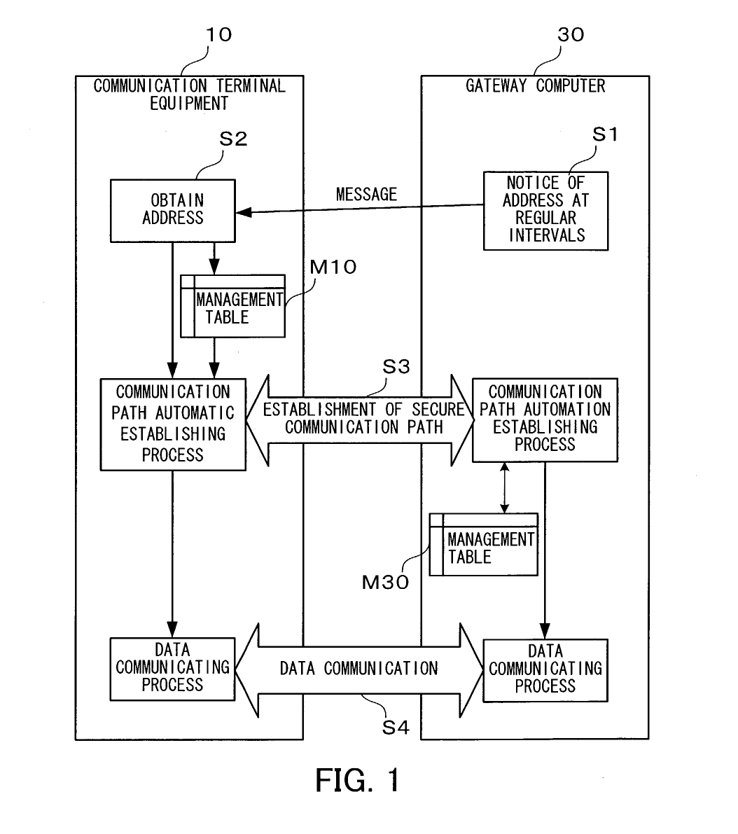

FIG. 1 is a conceptual view according to the present invention. A communication control program provided on the gateway side according to the present invention is applied to a relay of data to be communicated between a wireless network and another network. A communication control program provided on the side of a communication terminal equipment according to the present invention is applied to data communication to be executed through the wireless network. Hereafter, the process to be executed by these two programs in concert will be described along step numbers.

In FIG. 1 is illustrated a process of data communication to be executed between a communication terminal equipment (simply referred to as a terminal equipment through the later description except the claims) 10 for performing the data communication through the wireless network and a gateway (referred to as a gateway computer) 30 for relaying the data to be communicated between the wireless network and another network.

At first, the gateway computer 30 periodically broadcasts a message that the wireless network secures a security capability to the terminal equipment 10 (step S1).

Next, when the terminal equipment 10 enters into the communicable range serviced by the wireless network, the terminal equipment 10 obtains an address of the gateway computer 80 having a security capability through the wireless network (step S2). Further, the terminal equipment 10 communicates data with the gateway computer 30 based on the obtained address and determines an authenticating system and an encrypting and a decrypting rules of data to be communicated. (Hereafter, the securing technology including the determination of the encrypting and decrypting rules and the authentication with each other is wholly defined as establishing a secure communication path.) On the other hand, in response to a request from the terminal equipment 10 having received the message, the gateway computer 30 communicates data with the terminal equipment 10 and establishes a secure communication path for the data to be communicated (step S3).

Then, the gateway computer 30 encrypts the data destined for the terminal equipment 10 according to the encrypting rule and then transmits the encrypted data to the terminal equipment 10 through the wireless network. Moreover, the gateway computer 30 decrypts the other encrypted data received from the terminal equipment 10 through the wireless network. On the other hand, the terminal equipment 10 encrypts the data destined for another computer according to the encrypting rule and then transmits the encrypted data to the gateway computer 30 through the wireless network. The terminal equipment 10 decrypts the other encrypted data received from the gateway computer 30 through the wireless network according to the decrypting rule (step S4). These series of operations complete the data communication between the terminal equipment 10 and the gateway computer 30.

As described above, according to the invention, the message for indicating that the security capability is secured is broadcast at regular intervals to the terminal equipment 10 by the gateway computer 30.

When the terminal equipment 10 enters into the communicable range serviced by the wireless network, the terminal equipment 10 obtains the address of the gateway computer 30 provided with the security capability through the wireless network. Further, the terminal equipment 10 communicates data with the gateway computer 30 based on the obtained address and establishes a secure communication path of the data to be communicated. On the other hand, in response to the request from the terminal equipment 10 received the message, the gateway computer 30 communicates the data with the terminal equipment 10 and establishes the secure communication of the data to be communicated.

Then, the gateway computer 30 encrypts the data destined for the terminal equipment 10 according to the encrypting rule and then transmits the encrypted data to the terminal equipment 10 through the wireless network. The gateway computer 30 decrypts the other encrypted data received from the terminal equipment 10 through the wireless network according to the decrypting rule. These series of operations complete the data communication between the gateway computer 30 and the terminal equipment 10. On the other hand, the terminal equipment 10 encrypts the data destined for another computer according to the encrypting rule and then transmits the encrypted data to the gateway computer 30 through the wireless network. The terminal equipment 10 decrypts the other encrypted data received from the gateway computer 30 through the wireless network according to the decrypting rule. These series of operations complete the data communication therebetween.

These operations make it possible to automatically specify a communication environment for each gateway computer and obtain a secure communication path therefor as keeping the security, thereby reducing the number of items to be specified by the user resulting from the change of the gateway computer from one to another and lessening the user's burden accordingly.

Hereafter, the embodiment of the invention will be concretely described.

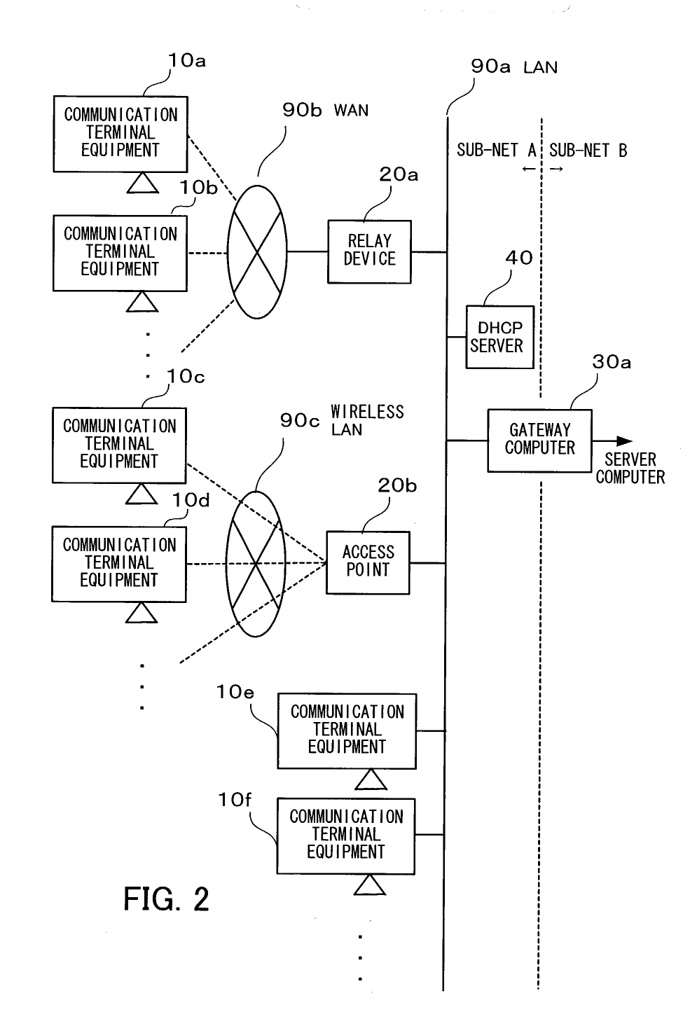

At first, the system to which the embodiment of the invention applies will be described with reference to FIG. 2.

FIG. 2 is a diagram showing a system structure to which the embodiment of the invention applies. This embodiment concerns the application of the IP (Internet Protocol)-based communication system to the present invention.

This embodiment is applied to a LAN system including terminal equipments 10a to 10f each having a wireless communication interface, a plurality of LAN nodes (relay device 20a and an access point 20b) each having a wireless communication interface, a gateway computer 30a having a security capability mounted therein, and a DHCP server 40 for dynamically allocating an IP address of each device. The overall LAN system is logically divided into sub-nets. A and B by the gateway computer 30a. The sub-net A is under the control of the gateway computer 30a, while the sub-net B is under the control of another gateway computer. The IP address of the terminal equipment 10 is not fixed but dynamically allocated by the DHCP (Dynamic Host Configuration Protocol) server. The IP address of the terminal equipment 10 is automatically allocated by, for example, a remote access server having the IPCP (Internet Protocol Control Protocol.) of the PPP (Point-to-Point Protocol). Herein, the sub-net A includes the relay device 20a, the access point 20b, and the terminal equipments 10e and 10f, all of which are connected to the gateway computer 30a through the LAN 90a and also connected through a secure communication path solid to the sub-net itself. In addition, the LAN 90a may be any means if it is a wired communication means for communicating a plurality of computers with one another.

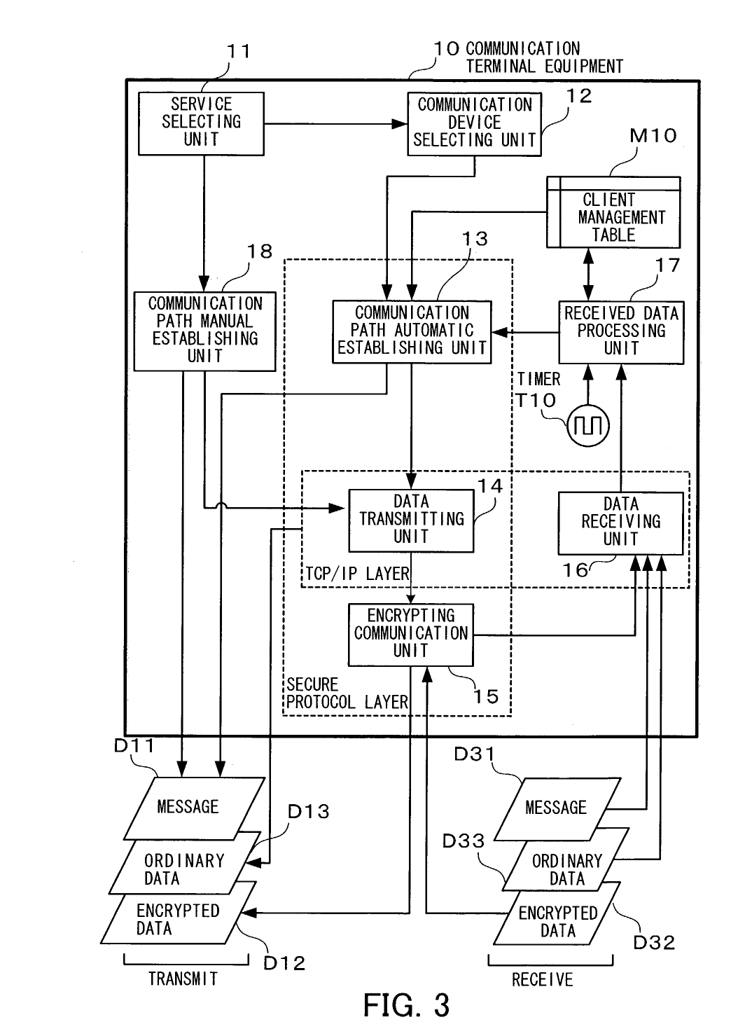

The terminal equipments 10a and 10b are connected with a WAN (Wide Area Network) 90b so that these terminal equipments may communicate data with another computer located in the sub-net A or another sub-net. When establishing a communication path for data communication, the terminal equipments 10a and 10b both operate to receive a message for a secure communication, notified at regular intervals by the gateway computer 30a, and then dynamically establish a secure communication path. The WAN 90b may be any means if it includes the relay device 20a arranged to communicate data with a computer located in a remote place. The terminal equipment 10a and 10b will be described in detail with reference to FIG. 3.

The terminal equipments 10c and 10d are connected with a wireless LAN 90c so that they may communicate data with another computer located in the sub-net A or another sub-net. When establishing a communication path for data communication, the terminal equipments 10c and 10d operate to receive a message for a secure communication, notified at regular intervals by the gateway computer 30a, and then dynamically establish a secure communication path. The wireless LAN 90c may be any means if it includes the access point 20b arranged to wirelessly connect with a computer. The terminal equipment 10c and 10d will be described in detail with reference to FIG. 3.

The terminal equipments 10e and 10f are both connected with a LAN 90a so that they may communicate data with another computer located in the sub-net A or another sub-net. When establishing a communication path for data communication, the terminal equipments 10e and 10f operate to receive a message for a secure communication, notified at regular intervals by the gateway computer 30a, and then dynamically establish a secure communication path. The terminal 10e or 10f will be described in detail with reference to FIG. 3.

The relay device 20a is connected with the gateway computer 30a and the WAN 90b so that the relay device 20a may relay the data communication between the gateway computer 20a and the terminal equipment 10a or 10b. The relay device 20 may be any means if it is served as a bridge or a switch for connecting two networks. For example, it may be a router or a remote access server.

The access point 20a is connected with the gateway computer 30a and the wireless LAN 90c so that the access point 20a may relay the data communication between the gateway computer 30a and the terminal equipment 10c or 10d. The relay device 20a may be any means if it is served as a bridge for connecting two networks.

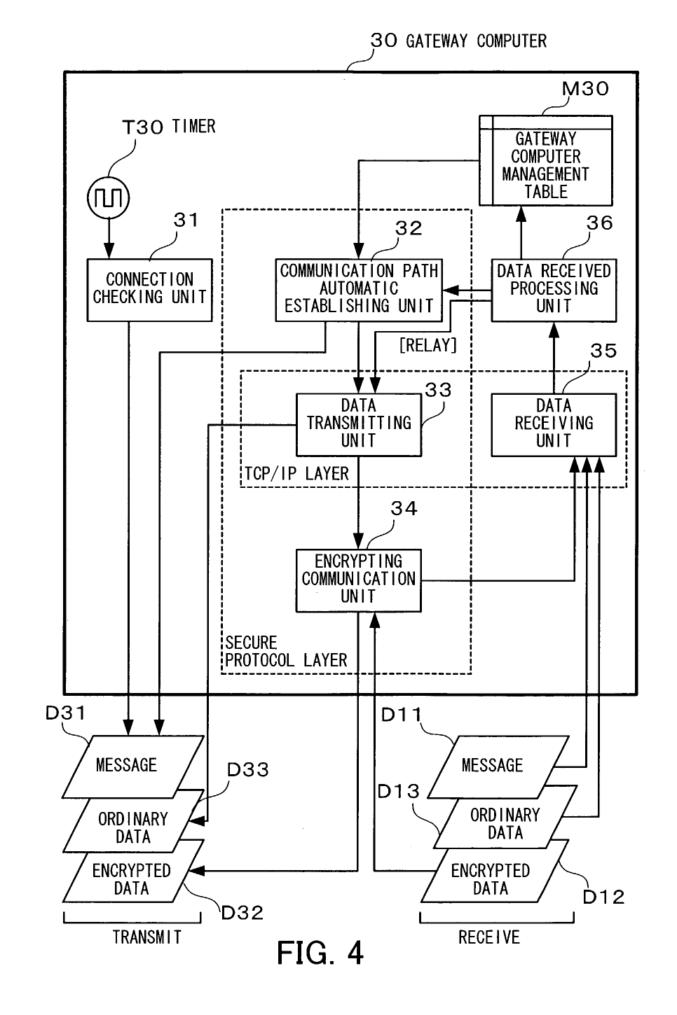

The gateway computer 30a is connected with the relay device 20a, the access point 20b, and the terminal equipments 10e and 10f through the LAN 90a so that the gateway computer 30a may relay the data communication between the computers located in the sub-net A or between a computer located in the sub-net A and a computer located in another sub-net. Further, the gateway computer 30a operates to notify the message for establishing a secure communication path to any computer located in the sub-net A at regular intervals. The gateway computer 30a will be described in detail with reference to FIG. 4.

The DHCP server 40 is connected with each device located in the sub-net A so that the server 40 may dynamically allocate an IP address to each device.

The foregoing arrangement makes it possible for the gateway computer 30a to broadcast at regular intervals the message for indicating securement capability of the security capability on the wireless LAN 90c to the terminal equipment 10c. Further, this arrangement allows the gateway computer 30a to communicate data with the terminal equipment 10c in response to the request from the terminal equipment 10c received the message and to establish a secure communication path for data communication with the terminal equipment 10c. Then, the gateway computer 30a encrypts the data destined for the terminal equipment 10c according to the encrypting rule and then transmit the encrypted data to the terminal equipment 10c through the wireless LAN 90c. Conversely, the gateway computer 30a decrypts the other encrypted data received from the terminal equipment 10c through the wireless LAN 90c according to the decrypting rule. These series of operations complete the data communication between the gateway computer 30a and the terminal equipment 10c.

On the other hand, the terminal equipment 10c obtains the address of the gateway computer 30a provided with the security capability through the wireless LAN 90c. The terminal equipment 10c communicates data with the gateway computer 30a based on the obtained address and establishes a secure communication path for data to be communicated. Then, the terminal equipment 10c encrypts the data destined for another computer (such as a server computer) according to the encrypting rule and transmits the encrypted data to the gateway computer 30a through the wireless LAN 90c. Conversely, the terminal equipment 10c decrypts the other encrypted data from another computer (such as a server computer), received from the gateway computer 30a through the wireless LAN 90c, according to the decrypting rule. These series of operations complete the data communication therebetween.

The foregoing process makes it possible to automate the communication settings such as establishment of a secure communication path as keeping the security.

In turn, the functional arrangement of the communication terminal equipment 10 according to an embodiment of the invention will be concretely described with reference to FIG. 3.

FIG. 3 is a function block diagram showing the communication terminal equipment according to an embodiment of the present invention.

In FIG. 3, the terminal equipment 10 is arranged to have a service selecting unit 11 for selecting an automatic establishment or a manual establishment of a secure communication path, a communication device selecting unit 11 for automatically selecting a communication device according to a priority sequence, a communication path automatic establishing unit (simply referred to as an automatic establishing unit through the later description except the claims) 13 for automatically establishing a secure communication path through which data is to be communicated, a data transmitting unit 14 for transmitting data, an encrypting communication unit (simply referred to as an encrypting unit through the later description except the claims) 15 for communicating encrypted data with another computer, a data receiving unit 16 for receiving a message D31, ordinary data D33, and decrypted data, a received data processing unit (simply referred to as a data processing unit through the later description except the claims) 17 for processing received data according to its data type, a communication path manual establishing unit (simply referred to as a manual establishing unit through the later description except the claims) 18 for manually establishing a communication path through which data is to be communicated, a client management table M10 for storing information like an address of the gateway computer 30, and a timer T10 for timing a current time.

The service selecting unit 11 is connected with the communication device selecting unit 12 and the manual establishing unit 18. It selects an automatic establishment or a manual one of the secure communication path. In this operation, the service selecting unit 11 is operated when powered up, when moved out of the service area, when the communication is disconnected, or on any predetermined timing. For example, when powered up, the service selecting unit 11 prompts the user to select a start of one service (meaning the automatic establishment of a secure communication path). Then, when the user selects the service start, the service selecting unit 11 passes the control to the communication device selecting unit 12. On the other hand, when the user selects the other service (meaning the manual establishment of a secure communication path), the service selecting unit 11 passes the control to the manual establishing unit 18.

The communication device selecting unit 12 is connected with the service selecting unit 11 and the automatic establishing unit 13 so that it may automatically select the communication device according to the priority sequence. In this operation, the communication device selecting unit 12 retrieve the communication device with the top priority specified in the priority sequence table (to be described later). After retrieved, the communication device selecting unit 12 determines whether or not the proper communication device is found. If it is found, the unit 12 passes the control to the automatic establishing unit 13. On the other hand, if no proper communication device is found, the unit 12 notifies a managing function of the TCP/IP layer of the fact that all communication devices are unavailable. In response to this notice, the terminal equipment 10 causes the application software arranged to use the TCP/IP layer to recognize a communication error. The communication device selecting unit 12 will be described later in detail.

The automatic establishing unit 13 is connected with the communication device selecting unit 12, the data transmitting unit 14, the data processing unit 17, and the client management table M10 so that it may automatically establish the communication path through which data is to be communicated. In this operation, the automatic establishing unit 13 obtains an address of the gateway computer 30 registered in the client management table M10 and then, in the secure protocol layer, executes the sequence of establishing a security protocol (secure communication path) between itself and the gateway computer 30. After the secure communication path is established, the automatic establishing unit 13 passes the control to the data transmitting unit 14 and notifies the unit 14 of the establishment of the secure communication path.

The data transmitting unit 14 is connected with the automatic establishing unit 13, the encrypting unit 15, and the manual establishing unit 18 so that it may transmit given data. In this operation, the data transmitting unit 14 passes the data specified by the user to the encrypting unit 15 in the TCP/IP layer. On the other hand, if the data is not required to be encrypted, the data is transmitted as the ordinary data D13 onto the network.

The encrypting unit 15 is connected with the data transmitting unit 14 and the data receiving unit 16 so that it may communicate the encrypted data with another computer. In this operation, the encrypting unit 15 encrypts the data passed from the data transmitting unit 14 and then transmits the encrypted data D12 to the gateway computer 30 in the secure protocol layer. On the other hand, when the encrypting unit 15 receives the encrypted data D32 transmitted from the gateway computer 30 in the secure protocol layer, the encrypting unit 15 decrypts the encrypted data D32 and then passes the decrypted data to the data receiving unit 16.

The data receiving unit 16 is connected with the encrypting unit 15 and the data processing unit 17 so that it may receive the message D31, the ordinary data D33, and the decrypted data. In this operation, the data receiving unit 16 received the data passed from the encrypting unit 15 and then passes it to the data processing unit 17 in the TCP/IP layer. Also, in the TCP/IP layer, the data receiving unit 16 receives the message D31 from the gateway computer 30 and then passes the message D31 to the data processing unit 17. When the terminal equipment 10 requests an IP address of the gateway computer 30, the terminal equipment 10 enables to obtain its own IP address from the DHCP server 40 through the effect of the DHCP protocol again. In this case, after the terminal equipment 10 requests the IP address of the gateway computer 30 from the DHCP server 40, the data receiving unit 16 receives the IP address from the DHCP server 40 and then passes it to the data processing unit 17.

The data processing unit 17 is connected with the automatic establishing unit 13, the data receiving unit 16, the client management table M10, and the timer T10 so that the unit 17 may process the received data according to its data type. In this operation, when the data processing unit 17 receives the message D31 for keeping the secure communication from the gateway computer 30, the data processing unit 17 determines the address included in the message D31 as a corresponding node for executing the secure communication with the terminal equipment 10 and then stores (registers) it in the client management table M10. At a time, the data processing unit 17 passes the control to the automatic establishing unit 13 and notifies the unit 13 of the fact that the message D31 is received and processed properly.

Further, the data processing unit 17 compares the new message (IP address) with the previous one. When the message D31 is newly received from the gateway computer 30, the data processing unit 17 obtains from the client management table M10 the previously received message (IP address) whose transmitting source is the previous gateway computer. When the terminal equipment 10 moves to another sub-net, the data processing unit 17 compares the obtained message (IP address) whose transmitting source is the previous gateway computer with the newly received message D31 (IP address) of the new gateway computer, for detecting a difference of the transmitting source between both of the messages. Since the difference is detected, the data processing unit 17 determines the terminal equipment 10 is connected with the different sub-net and stores the IP address of the current transmitting source in the client management table M10. After that, the terminal equipment 10 executes the communication through this new gateway computer.

Moreover, the data processing unit 17 monitors the connecting state. Actually, the unit 17 obtains the current time from the timer T10 at a time when it receives the message D31. The unit 17 also stores the obtained current time in the client management table M10. Further, the unit 17 stores the current time and at once resets the timer counter (sets the specified value). After that, the unit 17 causes the timer counter to count down on the current time of the timer 10. That is, the data processing unit 17 monitors the message from the gateway computer 30 received at regular intervals. Then, if the timer counter, which is being counted down, reaches “0” a certain length of time later, the unit 17 determines that it is moved out of the network under the control of the gateway computer 30. That is, since the message D31 is not received for a certain length of time, the terminal equipment 10 determines that it is moved out of the service area of the access point (dislocated from the support area). Or, it is determined that the line between the terminal equipment 10 and the access point is disconnected. Since it is determined that the terminal equipment 10 is moved out of the network based on this result, the data processing unit notifies the application software or the like arranged to use the TCP/IP layer of the fact that the network is cut off the terminal equipment 10 and thus is unavailable.

The data processing unit 17 also checks if the communication device may be connected with the network. At first, if the communication device selecting unit 12 selects a new communication device, as to the selected communication device, the data processing unit 17 waits for the message D31 from the gateway computer 30 for a certain length of time. Then, based on the result of the waiting, the data processing unit 17 determines if the message D31 is received. If it is received, the data processing unit 17 notifies the automatic establishing unit 13, the data transmitting unit 14, or the other application software arranged to use the TCP/IP layer and the secure protocol layer of the concerned communication device being available. On the other hand, unless the message D31 is received, the data processing unit 17 determines the concerned communication device is unavailable, and passes the control to the communication device selecting unit 12.

The manual establishing unit 18 is connected with the service selecting unit 11 and the data transmitting unit 14 so that it may manually establish a communication path through which data is to be communicated. If the process of manually establishing a communication path is selected by the service selecting unit 11, the manual establishing unit 18 establishes a communication path in response to the data manually inputted by a user and then notifies the data transmitting unit 14 of the fact that selected is the process of manually establishing a communication path.

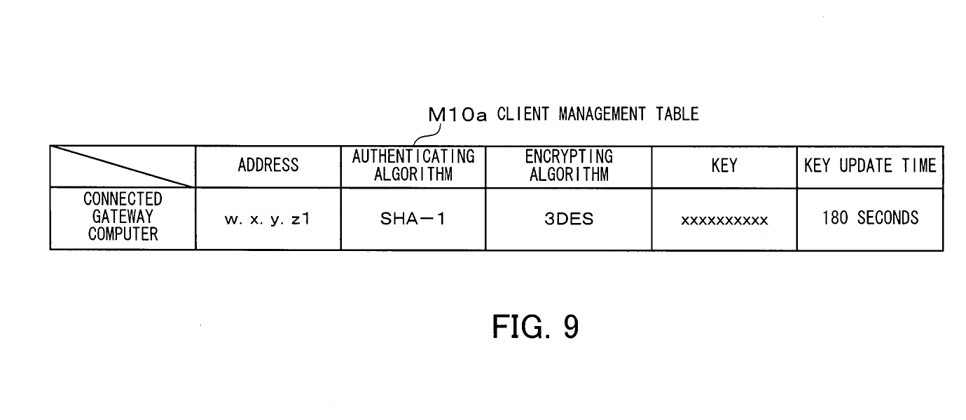

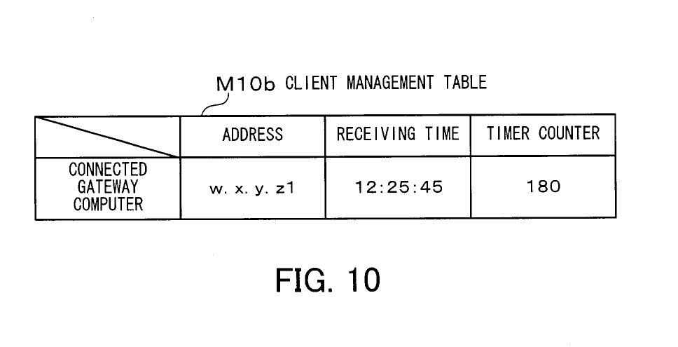

The client management table M10 is connected with the automatic establishing unit 13 and the data processing unit 17 so that it may store information like the address of the gateway computer 30. The client management table M10 stores the message D31, the data decrypted from the encrypted data D32, or the ordinary data D33, received from the data processing unit 17. Further, the client management table M10 obtains the address of the gateway computer 30 from the automatic establishing unit 13 and the data processing unit 17. The client management table M10 will be described in detail with reference to FIGS. 9 and 10.

The foregoing structure allows the service selecting unit 11 to select one of the processes of automatically establishing a secure communication path or manually establishing a secure communication path. If the automatic establishing process is selected by the service selecting unit 11, the communication device selecting unit 12 automatically selects the communication device according to the priority sequence. After the communication device is automatically selected, the automatic establishing unit 13 operates to automatically establish a communication path through which data is to be communicated. After the communication path is established, the data transmitting unit 14 transmits predetermined data. The predetermined data is transferred as the encrypted data with another computer by means of the encrypting unit 15.

On the other hand, on the receiving side, the data receiving unit 16 receives the message D31, the ordinary data D33, and the decrypted data. Based on the received data, the data processing unit 17 processes the received data according to its data type.

If the manual establishing process is specified by the service selecting unit 11, the manual establishing unit 18 operates to manually establish a communication path through which data is to be communicated.

The foregoing process makes it possible to automate the establishment of the secure communication path or the like.

In turn, the functional structure of the gateway computer 30 according to an embodiment of the present invention will be concretely described with reference to FIG. 4.

FIG. 4 is a function block diagram showing the gateway computer according to the embodiment of the invention. In FIG. 4, the gateway computer 30 is arranged to have a connection checking unit 31 for transmitting the message D31 at regular intervals, an automatic establishing unit 32, a data transmitting unit 33 for transmitting data, an encrypting unit 34 for communicating encrypted data with another computer, a data receiving unit 35 for receiving the message D11, the ordinary D13, and the decrypted data, a data processing unit 36 for processing the received data according to its data type, a gateway computer management table M30 for storing information like an address of the terminal equipment 10, and a timer T30 for counting a current time.

The connection checking unit 31 is connected with the timer T30 so that it may transmit the message D31 to the network at regular intervals. For example, when the gateway computer 30 is powered up, the connection checking unit 31 transmits the message D31 at regular intervals in an IP broadcasting manner.

The automatic establishing unit 32 is connected with the data processing unit 36 and the gateway computer management table M30 so that it may automatically establish a secure communication path through which data is to be communicated. In this operation, the automatic establishing unit 32 obtains an address of the terminal equipment 10 from the management table M30 and, in the secure protocol layer, executes the sequence of establishing a security protocol (secure communication path) with the terminal equipment 10. After the secure communication path is established, the automatic establishing unit 32 passes the control to the data transmitting unit 33 and at once notifies the unit 33 of the establishment of the secure communication path.

The data transmitting unit 33 is connected with the encrypting unit 34 and the data processing unit 36 so that it may transmit predetermined data. In this operation, the data transmitting unit 33 passes the data to the encrypting unit 34, because in the TCP/IP layer, it relays the data passed from the data processing unit 36 to the corresponding computer. On the other hand, if the encryption is not necessary, the data is transmitted as the ordinary data D33 to the network.

The encrypting unit 34 is connected with the data transmitting unit 33 and the data receiving unit 35 so that it may communicate the encrypted data with another computer. In this operation, in the secure protocol layer, the encrypting unit 34 decrypts the encrypted data D12 transmitted from the terminal equipment 10 and then passes the decrypted data to the data receiving unit 35. Further, in the secure protocol layer, the encrypting unit 34 encrypts the data passed from the data transmitting unit 33 and transmits the encrypted data D32 to the corresponding computer.

The data receiving unit 35 is connected with the data processing unit 36 so that it may receive the message D11, the ordinary data D13, and the decrypted data. In this operation, the data receiving unit 35 passes the data passed from the encrypting unit 34 to the data processing unit 36. Further, the data receiving unit 35 receives the message D11 or the ordinary data D13 from the terminal equipment 10 and then passes it to the data processing unit 36.

The data processing unit 36 is connected with the automatic establishing unit 32, the data transmitting unit 33, the data receiving unit 35, and the gateway computer management table M30 so that it may process the received data according to its data type. In this operation, the data processing unit 36 passes the data from the data receiving unit 35 to the data transmitting unit 33 for the purpose of relaying it to another computer. Further, when the message D11 for keeping secure communication is received from the terminal equipment 10, the data processing unit 36 stores the address and the information on authentication and encryption included in the message D11 in the gateway computer management table M30. At this time, the data processing unit 36 passes the control to the automatic establishing unit 32 and at once notifies the unit 32 of the fact that the message D11 is received properly.

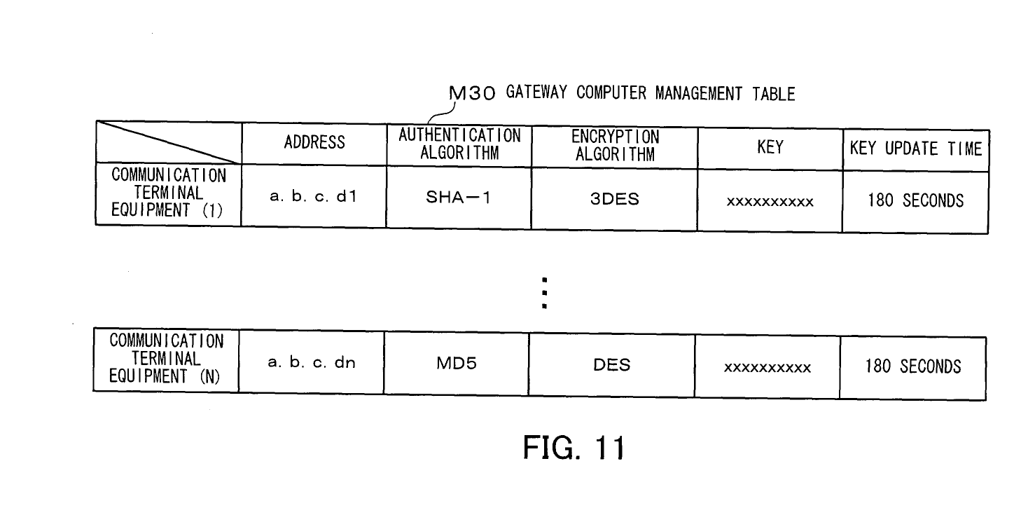

The gateway computer management table M30 is connected with the automatic establishing unit 32 and the data processing unit 36 so that the table M30 may store information like the address of the terminal equipment 10. In this operation, the gateway computer management table M30 is inputted with the received message D11 or the ordinary data D13, or the data decrypted by the encrypting unit 34 by the data processing unit 36 and then stores such data. Further, the address of the terminal equipment 10 is obtained from the management table M30 by means of the automatic establishing unit 32. The gateway computer management table M30 will be described in detail with reference to FIG. 11.

The foregoing structure allows the connection checking unit 31 to transmit the message D31 to the network at regular intervals. If the request of establishing a communication path is issued from the corresponding terminal equipment 10, the automatic establishing unit 32 operates to automatically establish a communication path through which data is to be communicated. When the data is passed by the data processing unit 36, the data transmitting unit 33 relays predetermined data. If the data needs to be encrypted, the encrypting unit 34 communicates the encrypted data with another computer.

On the other hand, on the receiving side, the data receiving unit 35 receives the message D11, the ordinary data D13, and the decrypted data. If the received data is passed, the data processing unit 36 processes the received data according to its data type.

The foregoing operation makes it possible to automate the establishment of a secure communication path or the like.

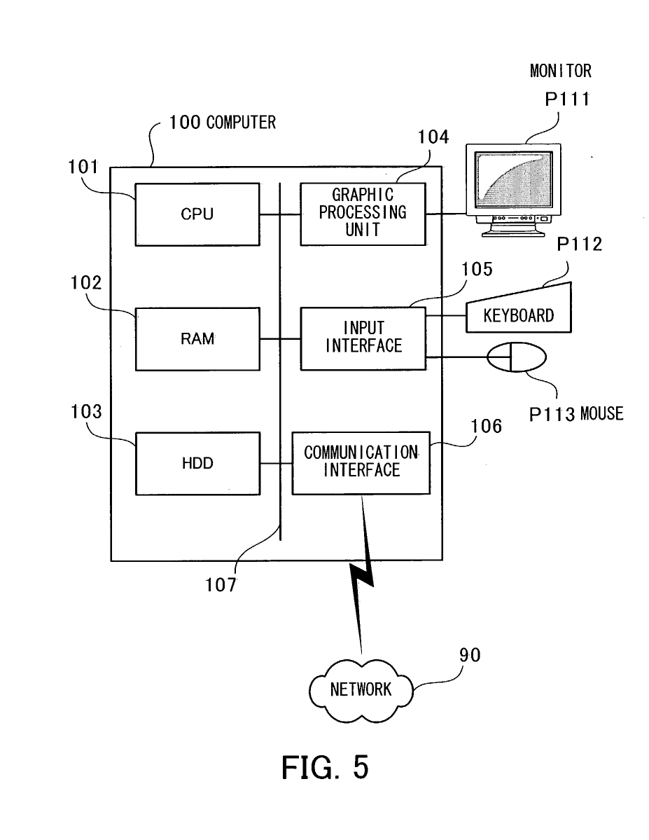

In turn, the hardware structure of the terminal equipment 10 and the gateway computer 30 according to an embodiment of the present invention is concretely described with reference to FIG. 5. The terminal equipment 10 and the gateway computer 30 may be realized by the unity hardware structure. In FIG. 5, the terminal equipment 10 and the gateway computer 30 are simply represented as a computer 100.

FIG. 5 shows the exemplary hardware structure of the terminal equipment and the gateway computer according to the embodiment of the present invention. The computer 100 is under the control of a CPU (Central Processing Unit) 101. The CPU 101 is connected with a RAM (Random Access Memory) 102, a harddisk drive (referred to as a HDD) 103, a graphic processing unit 104, an input interface 105, and a communication interface 106 through a bus 107.

The RAM 102 temporarily stores at least part of an OS and an application program to be executed by the CPU 101. Further, the RAM 102 also stores various kinds of data required by the processing of the CPU 101. The HDD 103 stores the OS, the application programs, and various kinds of data.

The graphic processing unit 104 is connected with a monitor P111. The graphic processing unit 104 displays an image on the screen of the monitor P111 in accordance with instructions issued by the CPU 101. The input interface 105 is connected with a keyboard P112 and a mouse P113. The input interface 105 transmits the signals sent from the keyboard P112 and the mouse P113 to the CPU 101 through the bus 107.

The communication interface 106 is connected with the network 90. The network 90 may be the LAN 90a, the WAN 90b, the wireless LAN 90c, all of which have been described with reference to FIG. 2, or a wide-area network like the internet. The communication interface 106 operates to communicate data with another computer through the network 90.

The foregoing hardware structure makes it possible to realize the processing function of the terminal equipment 10 and the gateway computer 30 according to the embodiment. For example, when the computer shown in FIG. 3 is powered up, a part of the OS program stored in the HDD 103 is read into the RAM 102. Then, the CPU 101 executes the OS program. This causes the OS to start on the CPU 101. The OS executes and manages the programs for realizing the functions associated with this embodiment of the invention.

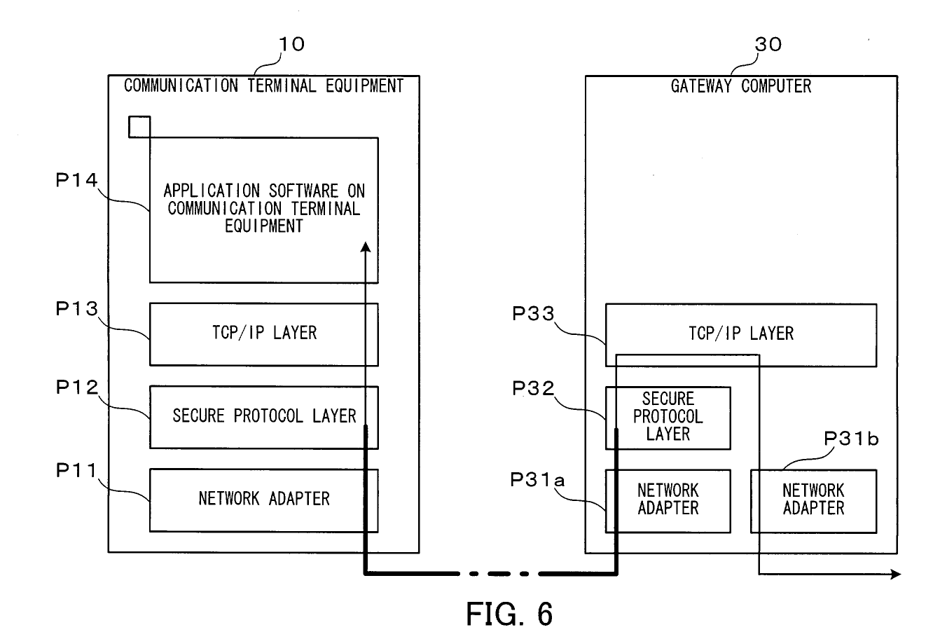

In turn, the hierarchical structure of the protocol stack included in the embodiment of the present invention is concretely described with reference to FIG. 6.

In FIG. 6, the protocol stack of the terminal equipment 10 has a four-storied structure composed of a network adapter P11, a secure protocol layer P12, a TCP/IP layer P13, and application software run on the terminal equipment 10 ranged from the bottom to the top in the describing sequence. Further, the protocol stack of the gateway computer 30 has a three-layer structure composed of layers of network adapters P31a and P31b, a secure protocol layer P32, and a TCP/IP layer P33 ranged from the bottom to the top in the describing sequence. In the secure protocol layer or the lower, the encrypted data is transferred.

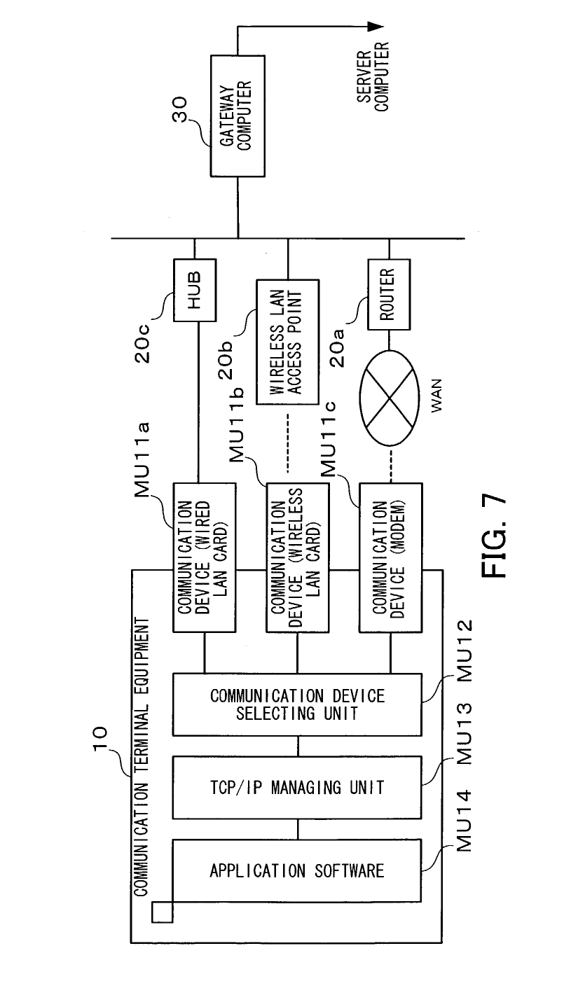

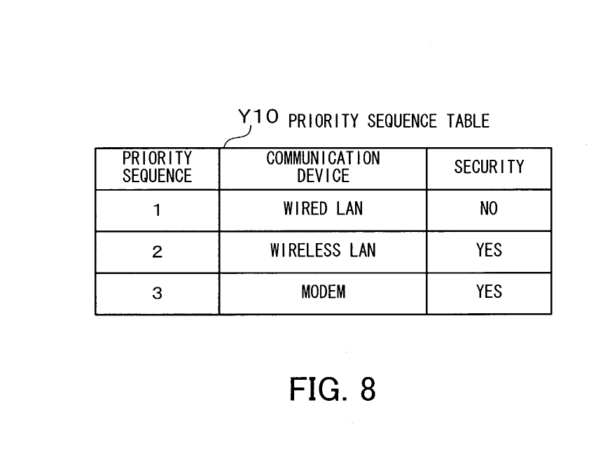

The communication devices to be selected according to the priority sequence in the terminal equipment 10 are concretely described with reference to FIGS. 7 and 8.

FIG. 7 shows a diagram of an example of the communication devices mounted in the terminal equipment.

In FIG. 7, the terminal equipment 10 includes a communication device MU11a (wired LAN card), a communication device MU11b (wireless LAN card), and a communication device MU11c (modem) mounted thereto. Those communication devices are all connected with a communication device selecting unit MU12, which is connected with a TCP/IP managing unit MU13. The TCP/IP managing unit MU13 controls data communication in the TCP/IP layer. This TCP/IP managing unit MU13 is also connected with the application software MU14 that utilizes the communication control program according to the present invention.

On the other hand, the communication device MU11a (wired LAN card) is connected with a HUB 20c. The communication device MU11b (wireless LAN card) is connected with the wireless LAN access point 20b. Further, the communication device MU11c (modem) is connected with a router 20a. The wireless LAN access point 20b, the router 20a, and the HUB 20c are connected with the gateway computer 30.

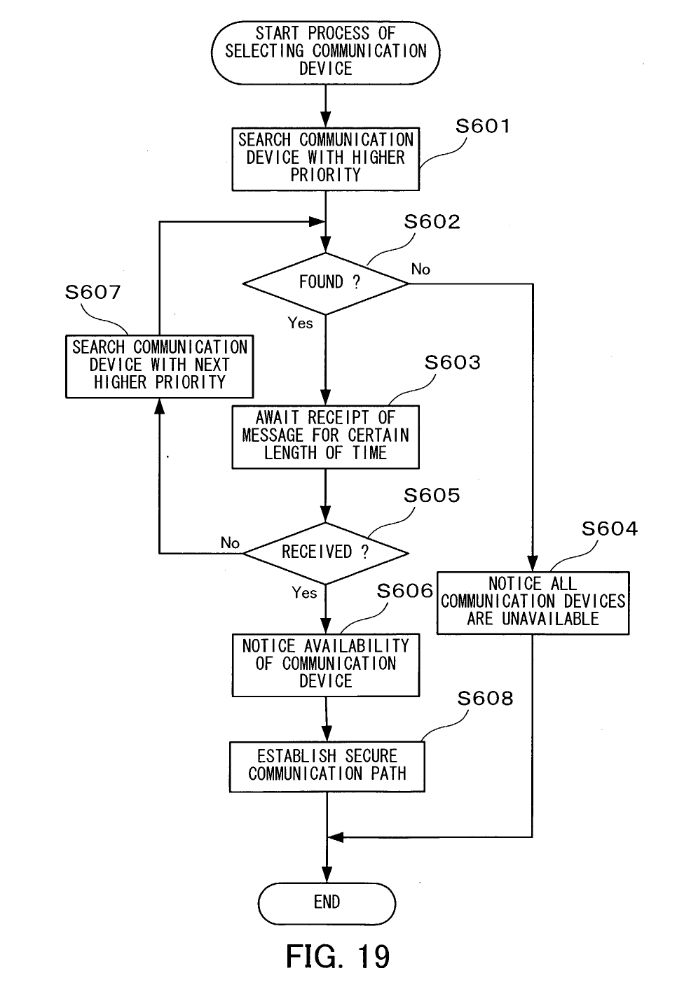

In this structure, the communication device selecting unit MU 12 of the terminal equipment 10 holds the predetermined priority sequence table of the communication devices to be selected in advance. The selecting unit MU12 automatically selects the communication device according to the priority sequence. The communication device selecting unit MU12 is processed by the foregoing communication device selecting unit 12. The priority sequence table will be described in detail with reference to FIG. 8. The process of selecting the communication devices will be described with reference to FIG. 19.

The mounting arrangement of the communication devices allows the communication device selecting unit MU12 to automatically select the communication device according to the priority sequence. The data is communicated with another computer or server computer through the desirous communication system.

FIG. 8 shows a table for indicating the priority sequence of the communication devices mounted in the terminal equipment.

In FIG. 8, the priority sequence table Y10 includes as its items a priority sequence, a communication device, and a security. In these items, for example, as the priority sequence “1” are specified the communication device “wired LAN” and the security “No”. Likewise, as the priority sequence “2” are specified the communication device “wireless LAN” and the security “Yes”. As the priority sequence “3” are specified the communication device “modem” and the security “No”.

In the foregoing priority sequence, for example, if all communication devices are connectable to the network, the communication device selecting unit MU12 selects the communication device “wired LAN” since the priority sequence “1” is proper. Then, since the security “no” is specified in the priority sequence “1”, the terminal equipment 10 establishes not a secure communication path as described with respect to the embodiments but an ordinary communication path.

Next, the data structure used in the embodiment will be described. FIGS. 9 and 10 show the data structure of the foregoing client management table M10. Herein, for convenience's sake, the table M10 is divided into two parts, that is, a client management table M10a and a client management table M10b, which will be described with reference to FIGS. 9 and 10, respectively.

FIG. 9 shows the structure of the data stored in the terminal equipment.

In FIG. 9, the client management table M10a stores the information used for establishing a secure communication path of the gateway computer to be connected with the terminal equipment. This table M10a includes as its items an “address” of the gateway computer 30 to be connected therewith, an “authentication algorithm” for authenticating the other party, an “encryption algorithm” for encrypting the data, a “key” used for encrypting the data, and a “key update time” for periodically updating the key. For these items, for example, “w. x. y. z1” is specified as the address, “SHA-1 (Secure Hashing Algorithm 1)” is specified as the authentication algorithm, “3DES (triple DES)” is specified as the encryption algorithm, “xxxxxxxxxx” is specified as the key, and “180 seconds” are specified as the key update time.

In the information specified as above, based on the authentication algorithm “SHA-1” and the encryption algorithm “3DES”, the terminal equipment establishes the secure communication path through which data is to be communicated with the gateway computer 30 specified to the address “w. x. y. z1”. For establishing the secure communication path and communicating data, the key “xxxxxxxxxx” is used for keeping privacy of the data. Further, the key is updated at periodic intervals, each of which is specified as “180 seconds”, for keeping secrecy of the encrypted data.

FIG. 10 shows the structure of data stored in the terminal equipment to be connected with the gateway computer when the timer is counting.

In FIG. 10, the client management table M10b stores the information used for monitoring the connecting state of the gateway computer 30 connected with the terminal equipment. This table M10b includes as its items an “address” of the gateway computer 30 connected therewith, a “receiving time” for indicating a receiving time of a message, and a “timer counter” for indicating a time passed since the receiving time. For these items, for example, “w. x. y. z1” is specified as the address, “12:25:45” is specified as the receiving time, and “180” is specified as the timer counter.

When the terminal equipment 10 receives a message from the gateway computer 30, the client management table M10b arranged as above allows the terminal equipment 10 to monitor the connection between the gateway computer 30 and the terminal equipment 10 itself. In the table M10b, the terminal equipment 10 specifies the receiving time at the message-received time and resets the timer counter (sets the timer counter to a predetermined value). Further, for the table M10b, the terminal equipment 10 constantly continues the countdown of the timer counter so that the predetermined value (180 specified in the example of FIG. 10) is set to the timer counter at a time when the timer counter is reset on the message receipt. Then, after being reset, the terminal equipment 10 causes the timer counter of the table M10b to continue the countdown again. When the timer counter reaches “0”, the timeout is determined.

FIG. 11 shows the structure of data stored in the gateway computer connected with the terminal equipment 10.

In FIG. 11, the gateway computer management table M30 stores the information used for establishing a secure communication path with the terminal equipment 10 connected therewith. This table M30 includes as its items an “address” of the terminal equipment connected with the gateway computer, an “authentication algorithm” for authenticating the other part, an “encryption algorithm” for encrypting data, a “key” used for encrypting the data, and a “key update time” for periodically updating the key. For these items, for example, “a. b. c. d1” is specified as the address, “SHA-1 (Secure Hashing Algorithm 1)” is specified as the authentication algorithm, “3DES (triple DES)” is specified as the encryption algorithm, “xxxxxxxxxx” is specified as the key, and “180 seconds” are specified as the key update time. In addition, a plurality of terminal equipments 10 may be registered, which are specified as shown in FIG. 11.

The information arranged as above allows the gateway computer 30 to establish a secure communication path and communicate data with the terminal equipment 10 “terminal equipment (1)” specified to the address “a. b. c. d1”, based on the authentication algorithm “SHA-1” and the encryption algorithm “3DES”. For establishing the secure communication path and communicating the data, the key “xxxxxxxxxx” is used for keeping privacy of the data. The key is updated at periodic intervals, each of which is specified as “180 seconds”, for keeping secrecy of the encrypted data.

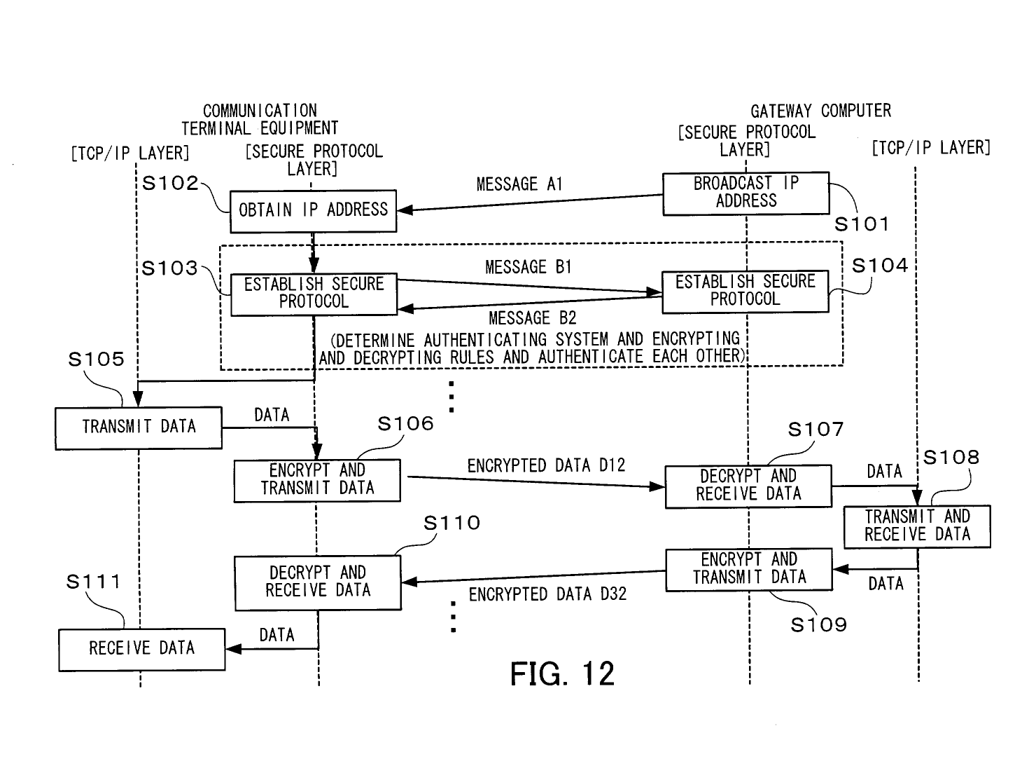

The basic operation of the embodiment will be concretely described with reference to FIGS. 12 to 19. In the description about the messages transferred in FIGS. 12 to 19, the foregoing message D11 shown in FIG. 3 is specified as the message A1 in the case of the IP broadcast and is replaced with the messages B1 and B2 in the case of establishing a secure communication path.

FIG. 12 is a flowchart showing an overall operation of the communication control program according to the embodiment. This process is started on a specific timing of the terminal equipment 10 or the gateway computer 30, such as a power-up, a dislocation from a service area, a disconnection, or any predetermined timing. The process is executed under the control of the CPU 101. Later, the process shown in FIG. 12 will be described along the step numbers. Each function of this flowchart is given a name with reference to FIGS. 2 to 4.

[Step S101] At first, the connection checking unit 31 of the gateway computer 30 transmits the message A1 to the overall sub-net A at regular intervals in the IP broadcasting manner.

[Step S102] The data receiving unit 16 of the terminal equipment 10 receives the message A1. The data processing unit 17 determines that the message transmitting source IP address is the gateway computer 30 and stores the transmitting source IP address in the client management table M10. Later, the communication from the terminal equipment 10 is executed through the gateway computer 30.

[Step S103] The automatic establishing unit 13 of the terminal equipment 10 obtains the IP address of the gateway computer 30 connected therewith. Then, in the secure protocol layer, the unit 13 executes the sequence of establishing a security protocol (secure communication path) between the terminal equipment itself and the gateway computer.

[Step S104] The automatic establishing unit 32 of the gateway computer 30 executes the sequence of establishing a security protocol (secure communication path) between the gateway computer 30 itself and the terminal equipment 10 in the secure protocol layer.

In the steps S103 and S104 determined are the authenticating system and the encrypting and the decrypting rules of the data to be communicated therebetween. According to the authenticating system, the authentication is executed between the terminal equipment 10 and the gateway computer 30.

[Step S105] In the TCP/IP layer, the data transmitting unit 14 of the terminal equipment 10 passes the data specified by the user to the encrypting unit 15 in preparation of transmitting the data.

[Step S106] In the secure protocol layer, the encrypting unit 15 of the terminal equipment 10 encrypts the data passed from the data transmitting unit 14 in the step S105 and then transmits the encrypted data D12 to the gateway computer 30.

[Step S107] In the secure protocol layer, the encrypting unit 34 of the gateway computer 30 receives and decrypts the encrypted data D12 transmitted from the terminal equipment 10 in the step S106 and passes the decrypted data to the data receiving unit 35.

[Step S108] The data receiving unit 35 of the gateway computer 30 passes the data passed from the encrypting unit 34 to the data processing unit 36. Then, the data processing unit 36 passes the data to the data transmitting unit 33 for the purpose of relaying the data to another computer. The data transmitting unit 33 passes the data to the encrypting unit 34 for the purpose of transmitting the data to the corresponding computer.

[Step S109] In the secure protocol layer, the encrypting unit 34 of the gateway computer 30 encrypts the data passed by the data transmitting unit 33 in the step S108 and then transmits the encrypted data D32 to the corresponding computer. In the example shown in FIG. 12, for convenience's sake in explanation, the corresponding computer is the terminal equipment 10.

[Step S110] On the other hand, in the secure protocol layer, the encrypting unit 15 of the terminal equipment 10 receives the encrypted data D32 transmitted from the gateway computer 30, decrypts the encrypted data D32, and passes the decrypted data to the data receiving unit 16.

[Step S111] In the TCP/IP layer, the data receiving unit 16 of the terminal equipment 10 receives the data passed in the step S110 and passes it to the data processing unit 17. Then, the data processing unit 17 passes the data to the application software or the like.

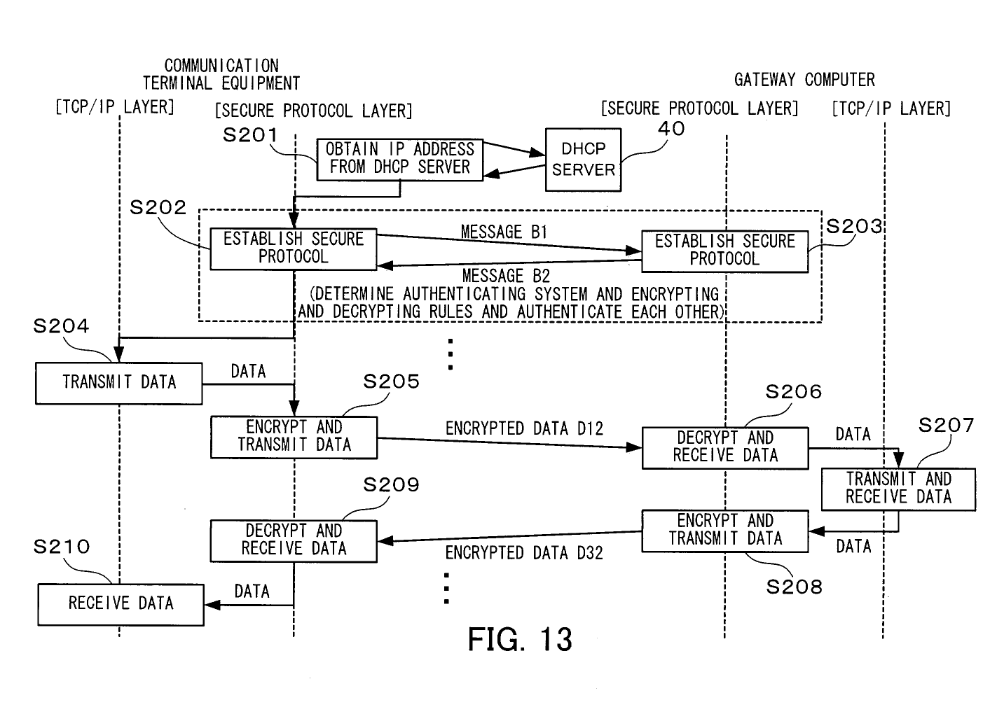

FIG. 13 is a flowchart showing the gateway in a case that the gateway computer is a default one in the overall operation of the communication control program shown in FIG. 12. This process is started on a specific time of the terminal equipment 10 or the gateway computer 30, such as the power-up, the dislocation from the service area, the disconnection, or any predetermined timing. The process is under the control of the CPU 101. Later, the process shown in FIG. 13 will be described along the step numbers. Each function of this flowchart is given a name with reference to FIGS. 2 to 4. FIG. 13 shows a DHCP server 40. If the gateway computer 30 is a default gateway, normally, by installing the DHCP server 40, the IP address of the gateway computer 30 can be obtained through the DHCP server 40. In this example, the DHCP server 40 is used for obtaining the IP address of the gateway computer 30. In place, another means may be used.

[Step S201] At first, the terminal equipment 10 requests the IP address of the gateway computer 30 from the DHCP server 40. The data receiving unit 16 of the terminal equipment 10 receives the IP address from the DHCP server 40 and then passes it to the data processing unit 17. The data processing unit 17 stores in the client management table M10 the IP address of the gateway computer 30 passed from the data receiving unit 16. Later, the communication from the terminal equipment 10 is executed through the gateway computer 30.

[Step S202] The automatic establishing unit 13 of the terminal equipment 10 obtains the IP address of the gateway computer 30 connected therewith. Then, in the secure protocol layer, the automatic establishing unit 13 executes the sequence of establishing a security protocol (secure communication path) between the terminal equipment 10 itself and the gateway computer 30.

[Step S203] In the secure protocol layer, the automatic establishing unit 32 of the gateway computer 30 executes the sequence of establishing a security protocol (secure communication path) between the gateway computer 30 itself and the terminal equipment 10.

In the steps S202 and S203 are determined the authenticating system and the encrypting and the decrypting rules of the data to be communicated therebetween. According to the authenticating system, the terminal equipment 10 and the gateway computer 30 are authenticated with each other.

[Step S204] In the TCP/IP layer, the data transmitting unit 14 of the terminal equipment 10 passes the data specified by the user to the encrypting unit 15 in preparation of transmitting the data.

[Step S205] In the secure protocol layer, the encrypting unit 15 of the terminal equipment 10 encrypts the data passed from the data transmitting unit 14 in the step S204 and transmits the encrypted data D12 to the gateway computer 30.

[Step S206] In the secure protocol layer, the encrypting unit 34 of the gateway computer 30 receives and decrypts the encrypted data D12 sent from the terminal equipment 10 in the step S205 and passes the decrypted data to the data receiving unit 35.

[Step S207] The data receiving unit 35 of the gateway computer 30 passes the data from the data receiving unit 35 to the data processing unit 36. Then, the data processing unit 36 passes the data to the data transmitting unit 33 for the purpose of relaying it to another computer. And, the data transmitting unit 33 passes the data to the encrypting unit 34 in preparation of transmitting the data passed to the corresponding computer.

[Step S208] In the secure protocol layer, the encrypting unit 34 of the gateway computer 30 encrypts the data passed by the data transmitting unit 33 in the step S207 and transmits the encrypted data to the corresponding computer. In the example shown in FIG. 13, for convenience's sake in explanation, the corresponding computer is the terminal equipment 10.

[Step S209] On the other hand, in the secure protocol layer, the encrypting unit 15 of the terminal equipment 10 receives the encrypted data D32 transmitted from the gateway computer 30. Then, the encrypting unit 15 decrypts the encrypted data D32, and passes the decrypted data to the data receiving unit 16.

[Step S210] In the TCP/IP layer, the data receiving unit 16 of the terminal equipment 10 receives the data passed in the step S209 and passes it to the data processing unit 17. Then, the data processing unit 17 passes the data to the application software or the like.

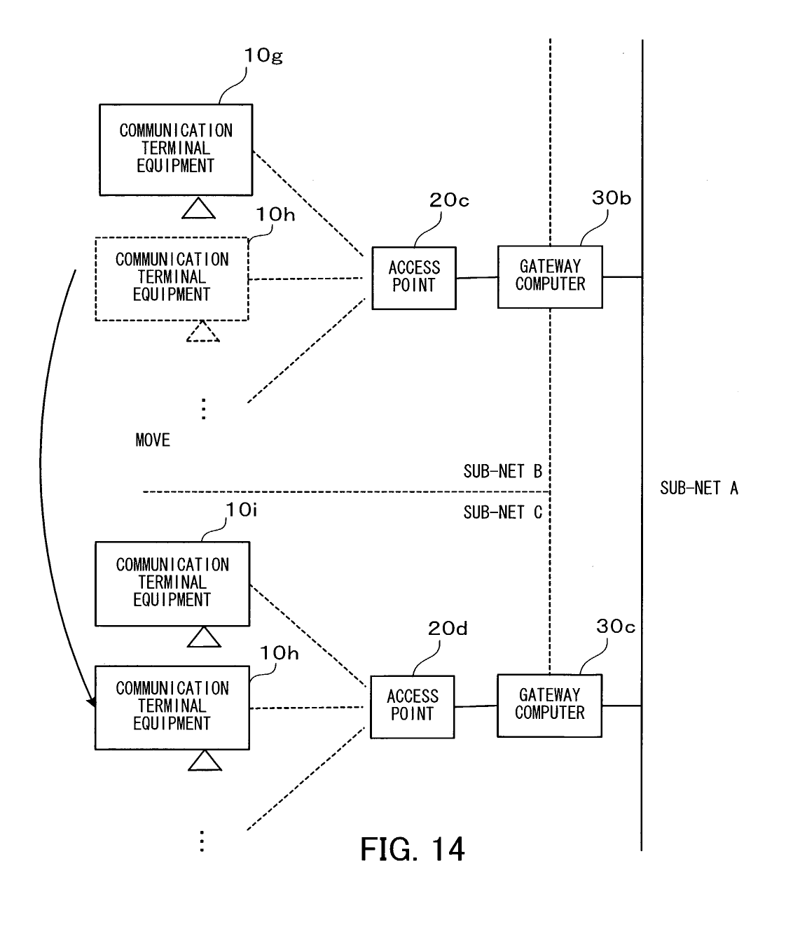

Herein, the description will be oriented to the case that the terminal equipment 10 moves from a sub-net to another sub-net with reference to FIGS. 14 to 16.

FIG. 14 shows the case that the terminal equipment 10 is moved to another sub-net in the LAN system to which the embodiment applies.

In FIG. 14, within the sub-net B are located a gateway computer 30b, an access point 20c, the terminal equipments 10g and 10h (the latter of which is shown in dotted line). Within the sub-net C are located a gateway computer 30b, an access point 20d, and the terminal equipment 10i.

In such an initial state, assume that the terminal equipment 10h (dotted line) is moved from the position of the connection with the gateway computer 30b to the position of the terminal equipment 10h (solid line) through the access point 20c.

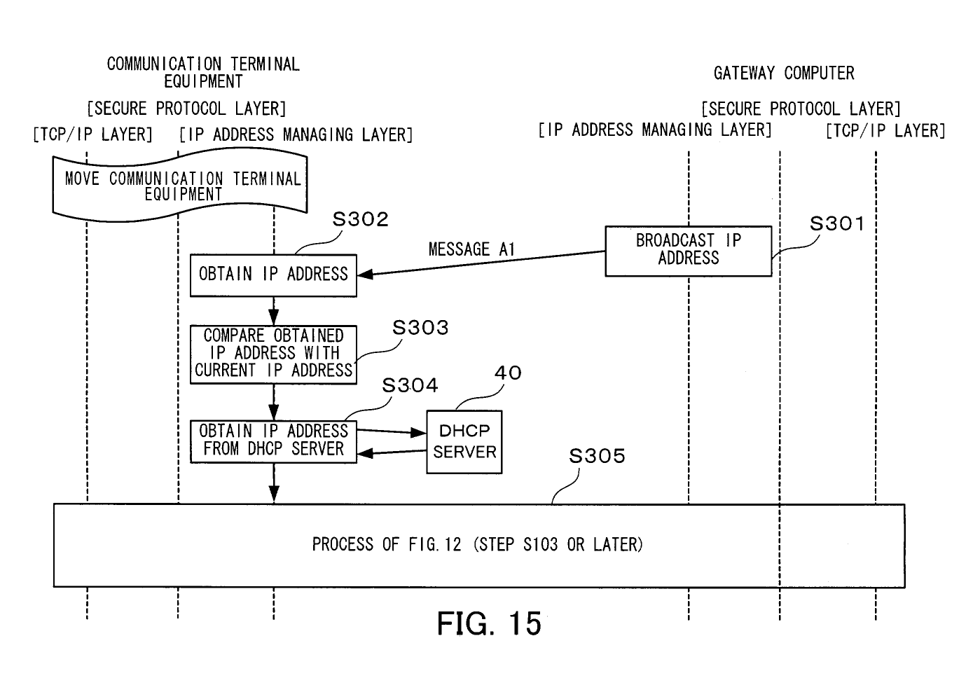

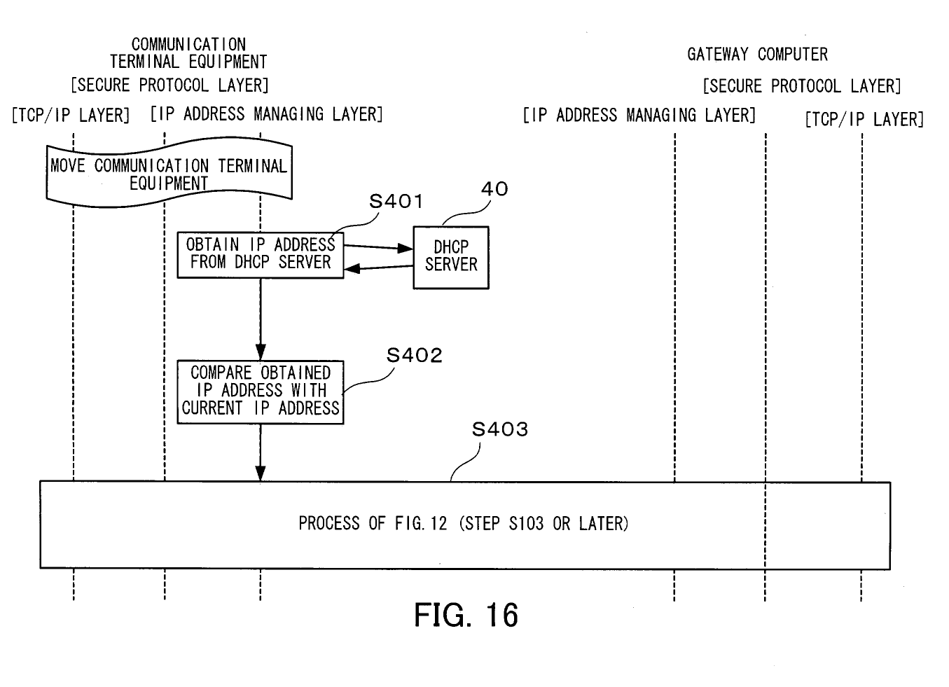

In this assumption, the process is executed along the flowcharts shown in FIGS. 15 and 16.

FIG. 15 is a flowchart showing an overall operation in the case of moving the terminal equipment according to this embodiment of the invention. This process is started when the terminal equipment 10h moves out of the sub-net B managed by the gateway computer 30b and joins in another sub-net C managed by the gateway computer 30c. The process is under the control of the CPU 101. Later, the process shown in FIG. 15 will be described along the step numbers. Each function of this flowchart is given a name with reference to FIGS. 2 to 4 and FIG. 14.

[Step S301] At first, the connection checking unit 31 of the gateway computer 30c transmits the message A1 to the overall sub-net C at regular intervals and in the IP broadcasting manner.

[Step S302] In the TCP/IP layer, the data receiving unit 16 of the moved terminal equipment 10h receives the message A1 from the gateway computer 30c. Then, the data receiving unit 16 passes the received message A1 to the data processing unit 17.

[Step S303] The data processing unit 17 of the terminal equipment 10h compares the previously received message whose transmitting source is the gateway computer 30b with a newly received message A1, for detecting a difference of the transmitting source between both of the messages. Further, since the difference of the transmitting source is detected, the data processing unit 17 determines that the terminal equipment 10h is connected with a different sub-net.

[Step S304] Based on the DHCP protocol, the terminal equipment 10h obtains its own IP address from the DHCP server 40 again. Afterwards, the terminal equipment 10h recognizes that the gateway computer 30c is the computer connected therewith.

[Step S305] Since it is recognized that the gateway computer 30c is the corresponding one in the step S304, the terminal equipment 10h establishes a secure communication path through which data is to be communicated between the terminal equipment 10h itself and the gateway computer 30c. The establishment of the secure communication path and the data communication are not described in detail, because they are likewise to the process of the step S103 or later in FIG. 12.

FIG. 16 is a flowchart showing an overall operation in the case that the terminal equipment according to the embodiment is moved and that the gateway computer is a default one. This process is started when the terminal equipment 10h is moved out of the sub-net B managed by the gateway computer 30b and then joins in the sub-net B managed by the gateway computer 30c. The process is under the control of the CPU 101. Later, the process shown in FIG. 15 will be described along the step numbers. Each function indicated in this flowchart is given a name with reference to FIGS. 2 to 4 and FIG. 14.

[Step S401] At first, the terminal equipment 10h that joins in the sub-net C requests the IP address of the gateway computer 30c from the DHCP server 40. The data receiving unit 16 of the terminal equipment 10h receives the IP address from the DHCP server 40 and passes it to the data processing unit 17. The data processing unit 17 stores the IP address of the gateway computer 30c in the client management table M10. Afterwards, the communication from the terminal equipment 10h is executed through the gateway computer 30c. In requesting the IP address of the gateway computer 30c, based on the DHCP protocol, the terminal equipment 10h may obtain its own IP address from the DHCP server 40. In the example shown in FIG. 16, it is assumed that the IP address of the terminal equipment 10h was re-obtained in advance.

[Step S402] The data processing unit 17 of the terminal equipment 10h compares the previously received address of the gateway computer 30b with the newly received address of the gateway computer 30c, for detecting a difference of the gateway computer therebetween. The difference causes the data processing unit 17 to determine that the terminal equipment 10h is connected with the different sub-net. Afterwards, it is recognized that the gateway computer 30c is used as the gateway computer connected with the terminal equipment 10h.

[Step S403] Since it is recognized that the used computer is the gateway computer 30c in the step S402, the terminal equipment 10h establishes a secure communication path and data communication with the gateway computer 30c. The establishment of the secure communication path and the data communication therethrough are likewise to the process of the step S103 or later in FIG. 12. Hence, the description thereabout is left out.

When the terminal equipment joins in a different network, the prior art needs to perform some kind of manual operation such as restart of the OS for establishing the security protocol (secure communication path) again. However, the communication control procedure according to this embodiment allows the terminal equipment 10h to check the message from the gateway computer 30c, thereby making it possible to automatically and quickly detect the connection of the terminal equipment with the different network.

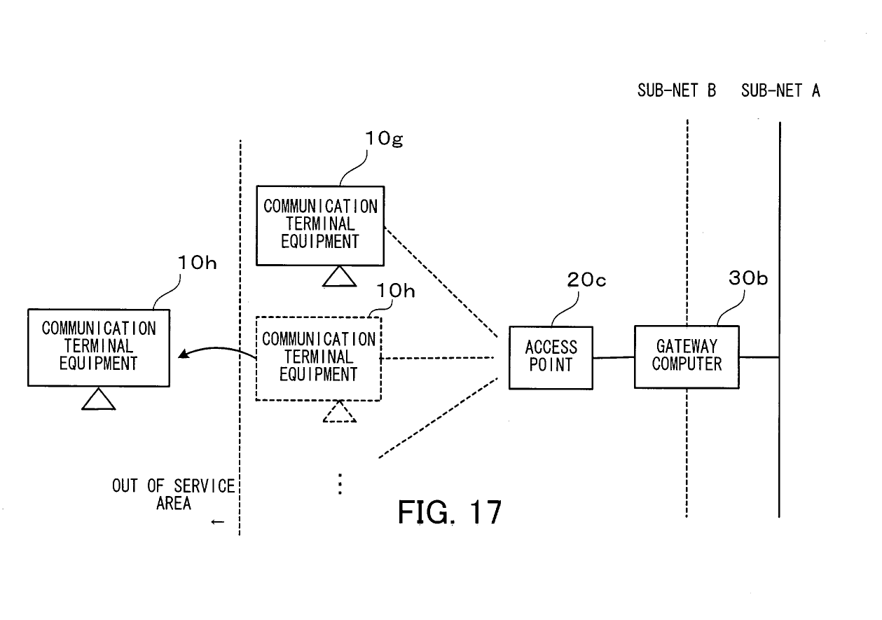

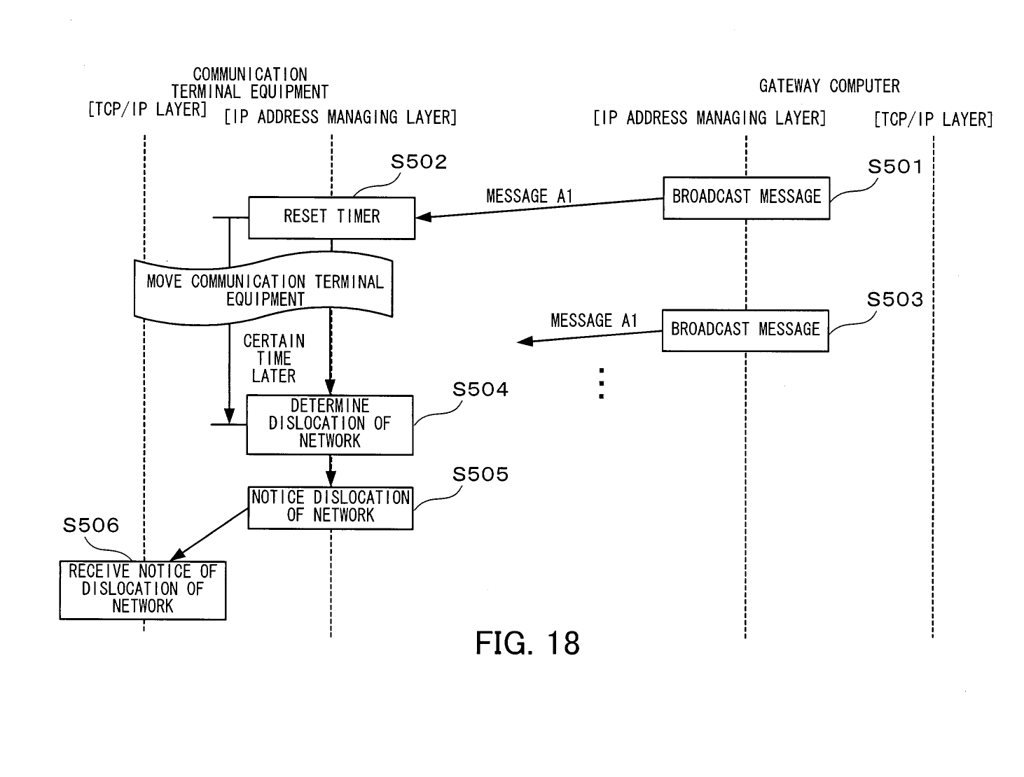

The description will be oriented to the case that the terminal equipment 10h disables to use the access point 20c, for example, it is moved out of the service area of the access point 20c with reference to FIGS. 17 and 18.

FIG. 17 is a view showing the case that the terminal equipment is moved out of the service area in the LAN system to which this embodiment applies.

In FIG. 17, within the sub-net B are located the gateway computer 30b, the access point 20c, and the terminal equipments 10g and 10h (the latter of which is shown in dotted line).

In such an initial state, the terminal equipment 10h (dotted line) is being connected with the gateway computer 30b through the access point 20c (for example, a wireless LAN) (meaning the terminal equipment 10h stays in the support area). Then, the terminal equipment 10h is disconnected from the state, that is, the network (sub-net B0 on account of the movable dislocation from the support area. In this assumption, for example, in FIG. 17, the terminal equipment 10h (dotted line) is moved to the position of the terminal equipment 10h (solid line) located out of the service area of the access point 20c.

In the assumptive removal, the process is executed along the flowchart shown in FIG. 18.

FIG. 18 is a flowchart showing the overall operation in the case that the terminal equipment according to this embodiment is moved out of the service area. This process is started when the terminal equipment 10h is moved out of the service area of the access point 20c in the sub-net B managed by the gateway computer 30b. The process is under the control of the CPU 101. Later, the process shown in FIG. 18 will be described along the step numbers. Each function in this flowchart is given a name with reference to FIGS. 2 to 4 and FIG. 17.

[Step S501] At first, the connection checking unit 31 of the gateway computer 30b transmits the message A1 to the overall sub-net B at regular intervals and in the IP broadcasting manner.

[Step S502] In the TCP/IP layer, the data receiving unit 16 of the terminal equipment 10h moved to another area receives the message A1 from the gateway computer 30b. Then, the data receiving unit 16 passes the received message A1 to the data processing unit 17. In response to the message A1, the data processing unit 17 obtains the current time from the timer T10 and stores the obtained current time in the client management table M10. Further, the unit 17 resets the timer counter (set a predetermined value) at a time when the current time is stored in the table M10. Afterwards, the unit 17 causes the timer counter to count down from the current time obtained from the timer T10. It means that the terminal equipment 10h monitors the message from the access point 20c, which message is relayed at regular intervals.

[Then, the terminal equipment 10h is moved out of the service area of the access point 20c.]

[Step S503] The connection checking unit 31 of the gateway computer 30b re-transmits the message A1 to the overall sub-net B in the IP broadcasting manner. In the example shown in FIG. 18, the message A1 does not reach the terminal equipment 10h, because it has been already moved out of the network.

[Step S504] Since the timer counter that is counted down in the step S502 reaches “0” a certain length of time later, the data processing unit 17 of the terminal equipment 10h determines that the network is moved out of the network. That is, since the message A does not reach the terminal equipment 10h during a certain length of time, it is determined that the terminal equipment 10h is moved out of the service area of the access point 20c (dislocated from the support area). Or, it is determined that the connection between the terminal equipment 10h and the access point 20c is cut off.

[Step S505] Since the dislocation from the network is determined in the step S503, the data processing unit 17 of the terminal equipment 10h notifies the device driver, the API and the like arranged to use the TCP/IP layer of the fact that the network is cut off and thus made unavailable.

[Step S506] The device driver, the API and the like arranged to use the TCP/IP layer receive the fact that the network is cut off and thus made unavailable.

The terminal equipment 10h, therefore, enables the application software arranged to use the TCP/IP protocol to recognize a communication error. Later than this, the communication from the terminal equipment 10h is disabled.

The prior art does not provide any means of detecting a disconnection of the terminal equipment 10h from the gateway computer 30h. Hence, the prior art has been required to perform a manual operation of shifting to the recovering process on the terminal equipment 10h. However, the embodiment of the present invention provides means of automatically detecting a disconnection of the terminal equipment 10h from the gateway computer 30b. This allows the user to reduce the time required for the recovering process.

In turn, the description will be oriented to the process of selecting the communication device in the communication device selecting unit MU12 shown in FIG. 7 and the communication device selecting unit 12 shown in FIG. 3 with reference to FIG. 19.

FIG. 19 is a flowchart showing a basic operation of the process of selecting the communication devices according to the embodiment of the present invention. This process is started when the terminal equipment 10 passes the control to the communication device selecting unit 12, that is, the service selecting unit 11 selects the process of automatically establishing the communication path. The process is under the control of the CPU 101. Later, the process shown in FIG. 19 will be described along the step numbers. Each function in this flowchart is given a name with reference to FIG. 3.

[Step S601] The communication device selecting unit 12 of the terminal equipment 10 retrieves the communication device with the top priority from the communication device priority sequence table Y10.

[Step S602] The communication device selecting unit 12 determines if the proper communication device is found on the basis of the retrieved result in the step S601. If it is found, the process goes to a step S603, while if it is not found, the process goes to a step S604.

[Step S603] Since the proper communication device is found in the step S602, as to the proper communication device, the data processing unit 17 of the terminal equipment 10 awaits a receipt of the message D31 from the gateway computer 30 for a certain length of time.

[Step S604] Since no proper communication device is found in the step S602, the data processing unit 17 notifies the TCP/IP layer of the fact that all communication devices are unavailable. The terminal equipment 10 thus enables the application software arranged to use the TCP/IP protocol to recognize a communication error.

[Step S605] As a result of awaiting the message in the step S603, the data processing unit 17 determines if the message D31 is received. If the message D31 is received, the process goes to a step S606, while if the message D31 is not received, the process goes to a step S607.

[Step S606] Since the message D31 is received in the step S604, the data processing unit 17 notifies the automatic establishing unit 13 and the data transmitting unit 14 arranged to use the TCP/IP layer and the secure protocol layer of the fact that the selected communication device is available and the other communication devices are unavailable.

[Step S607] Since the message D31 is not received in the step S604, it is determined that the selected communication device is unavailable. Then, the communication device selecting unit 12 retrieves the communication device with the next priority.

[Step S608] Since the selected communication device is available, the automatic establishing unit 13 executes the sequence of establishing a secure communication path.

The foregoing communication control procedure makes it possible to automate communication settings for each gateway computer and securement of a secure communication path as keeping the security. This results in reducing the number of items to be specified by the user each time the gateway computer is changed, thereby lessening the burden imposed on the user.

The aforementioned process is described in a computer program and thus is executed by the computer. This causes the functions of the present invention to be realized. When the process is executed by the computer, the computer program is pre-stored on a harddisk located in the computer and then is loaded onto a main memory before the execution. The computer program may be recorded on a computer-readable medium. These kinds of mediums may be a magnetic recording medium, an optical disk, a magneto-optical recording medium, a semiconductor memory, and so forth. The magnetic recording medium may be a harddisk, a flexible disk, a ZIP disk, a magnetic tape, and so forth. The optical disk may be a DVD (Digital Versatile Disc), a DVD-RAM (DVD Random Access Memory), a CD-ROM (Compact Disk Read Only Memory), a CD-R (CD Recordable), a CD-RW (CD Rewritable), and so forth. The magneto-optical recording medium may be a MO (Magneto Optical Disk) and the like. The semiconductor memory may be a flash memory and the like.

For distributing such a computer program, sold is a portable recording medium such as a DVD or a CD-ROM is sold and the computer program is recorded on the portable recording medium. Moreover, the computer program saved in a storage device of a server may be transferred from the server to a computer on the client side through a network.

The present invention having been described along the aforementioned embodiments has the following effects.

(1) Since the user selects the start of the service provided by the embodiment of the present invention in starting the communication (booting the PC), the user may selectively use a proper one of the communication through a secure communication path and the communication in the conventional communication environment (to which the embodiment of the present invention does not apply).

(2) When starting the communication or when moving the equipment terminal from one sub-net to another, the present invention provides a capability of automating the processes of specifying and changing an address of the gateway computer and establishing a secure communication path. This makes it possible to remove the burden in specifying the items of the communication environment.

(3) The present invention enables to quickly detect dislocation of the terminal equipment from the service area of the gateway computer. This allows the user to reduce the time required for the recovering process.

(4) The present invention provides a capability of automatically selecting the communication interfaces according to the defined priority sequence in the terminal equipment having a plurality of communication interfaces mounted thereto. This makes it possible to automate the sequences of changing the communication environment in association with the change of the communication interface and establishing a secure communication path, that is, making these sequences transparent to the user, thereby removing the user's burden in specifying the environment.

As set forth above, the present invention is arranged to periodically transmit an address from the gateway computer to the corresponding terminal equipment and to determine the authenticating system and the encrypting and the decrypting rules between the terminal equipment and the gateway computer. This makes it possible to automate the sequences of specifying the communication environment items, establishing a secure communication path, and so forth as keeping the security in the communication path. This leads to reducing the number of the items to be specified by the user in association with the change of the gateway computer, thereby lessening the user's burden.

The foregoing is considered as illustrative only of the principles of the present invention. Further, since numerous modifications and changes will readily occur to those skilled in the art, it is not desired to limit the invention to the exact construction and application shown and described, and accordingly, all suitable modifications and equivalents may be regarded as falling within the scope of the invention in the appended claims and their equivalents.

What is claimed is:

1. A communication control program on the side of a gateway, for relaying data to be transferred between a wireless network and another network, causing a computer to execute the process comprising the steps of:
periodically transmitting a message for indicating securement of a security capability on said wireless network in a broadcasting manner;
communicating data with a communication terminal equipment in response to a request from said communication terminal equipment received said message, determining an authenticating system and an encrypting and a decrypting rules for the data to be communicated, and giving an authentication between said gateway and said communication terminal equipment according to said authenticating system; and
encrypting data destined for said communication terminal equipment according to said encrypting rule, transmitting said encrypted data through said wireless network, and decrypting said encrypted data received from said communication terminal equipment through said wireless network according to said decrypting rule.

2. The communication control program on the side of a gateway according to claim 1, wherein when determining said authenticating system and said encrypting and decrypting rules, an address of said communication terminal equipment included in said message received at said determination time is stored on a storage medium located inside said equipment.

3. The communication control program on the side of a gateway according to claim 2, wherein said authenticating system and said encrypting and decrypting rules are determined on the basis of said address of said communication terminal equipment stored on said storage medium.

4. A communication control program on the side of a communication terminal equipment, for communicating data through a wireless network, causing a computer to execute the process comprising the steps of:
obtaining an address of a gateway having a security capability through said wireless network when said communication terminal equipment comes into a communicable area serviced by said wireless network;
communicating data with said gateway based on said obtained address, determining an authenticating system and an encrypting and a decrypting rules for the data to be communicated, and authenticating said gateway and said communication terminal equipment according to said authenticating system; and
encrypting data destined for another computer according to said encrypting rule, transmitting said encrypted data to said gateway through said wireless network, and decrypting said decrypted data received from said gateway through said wireless network according to said decrypting rule.

5. The communication control program on the side of a communication terminal equipment according to claim 4, wherein when receiving said message, said address of said gateway included in said message is obtained and then is stored on a storage medium located inside said equipment.

6. The communication control program on the side of a communication terminal equipment according to claim 5, wherein said authenticating system and said encrypting and decrypting rules are determined on said gateway address stored on said storage medium.

7. The communication control program on the side of a communication terminal equipment according to claim 4, wherein when obtaining said gateway address, said address is obtained from said message periodically transmitted to said gateway through said wireless network in a broadcasting manner.

8. The communication control program on the side of a communication terminal equipment according to claim 4, wherein when obtaining said gateway address, by obtaining said gateway address from another server, said communication terminal equipment communicates data with said gateway so that said authenticating system and said encrypting and said decrypting rules may be automatically determined.

9. The communication control program on the side of a communication terminal equipment according to claim 8, wherein if the change of said gateway address is detected in obtaining said address, said communication terminal equipment communicates data with said gateway so that said authenticating system and said encrypting and said decrypting rules may be determined again.

10. The communication control program on the side of a communication terminal equipment according to claim 4, wherein if said communication terminal equipment includes a plurality of communicating means, said communication terminal equipment executes the process of checking for available communicating means in advance and if two or more communicating means are available, defining a priority sequence of each of said available communicating means in said communication terminal equipment; automatically selecting the proper communicating means according to said priority sequence, nullifying the other communicating means rather than said selected communicating means to be used, and communicating data with said gateway through said communicating means to be used, and determining said authenticating system and said encrypting and said decrypting rules.

11. A communication control method on the side of a gateway, for relaying data to be transferred between a wireless network and another computer, comprising the steps of:
periodically transmitting a message for indicating securement of a security capability on said wireless network in a broadcasting manner;
communicating data with said communication terminal equipment in response to a request from a communication terminal equipment having received said message, determining an authenticating system and an encrypting and a decrypting rules for the data to be communicated, and giving an authentication between said gateway and said communication terminal equipment according to said authenticating system; and
encrypting the data destined for said communication terminal equipment according to said encrypting rule, transmitting said encrypted data through said wireless network, and decrypting said encrypted data received from said communication terminal equipment through said wireless network according to said decrypting rule.

12. A communication control method on the side of a communication terminal equipment, for communicating data with a gateway through a wireless network, comprising the steps of:
obtaining an address of said gateway having a security capability through said wireless network, when said communication terminal equipment comes into a communicable area serviced by said wireless network;
communicating data with said gateway based on said obtained address and determining an authenticating system and an encrypting and a decrypting rules for the data to be communicated;
encrypting data destined for another computer according to said encrypting rule, transmitting said encrypted data to said gateway through said wireless network, and decrypting said encrypted data received from said gateway through said wireless network according to said decrypting rule.

13. A gateway for relaying data to be transferred between a wireless network and another network, comprising:
a connection checking unit of periodically transmitting a message for indicating securement of a security capability on said wireless network;
a communication path automatic establishing unit of communicating data with a communication terminal equipment in response to a request from said communication terminal equipment received said message, determining an authenticating system and an encrypting and a decrypting rules for data to be communicated, and giving an authentication between said gateway and said communication terminal equipment according to said authenticating system; and
encrypting data destined for said communication terminal equipment according to said encrypting rule, transmitting said encrypted data through said wireless network, and decrypting said encrypted data received from said communication terminal equipment through said wireless network according to said decrypting rule.

14. A communication terminal equipment for communicating data through a wireless network, comprising:
a received data processing unit of obtaining an address of a gateway having a security capability through said wireless network when said communication terminal equipment comes into a communicable area serviced by said wireless network;
a communication path automatic establishing unit of communicating data with said gateway based on said obtained address, determining an authenticating system and an encrypting and a decrypting rules for data to be communicated, and giving an authenticating between said gateway and said communication terminal equipment according to said authenticating system; and
an encrypting communication unit of encrypting data destined for another computer according to said encrypting rule, transmitting said encrypted data to said gateway through said wireless network, and decrypting said encrypted data received from said gateway through said wireless network according to said decrypting rule.

15. A computer-readable recording medium on which is recorded data to be transferred between a wireless network and another computer and a program on the side of a gateway to be relayed therebetween, causing said computer to execute the process comprising the steps of:
periodically transmitting a message for securement of a security capability on said wireless network in a broadcasting manner;
communicating data with a communication terminal equipment in response to a request from said communication terminal equipment having received said message, determining an authenticating system and an encrypting and a decrypting rules for data to be communicated, and giving an authentication between said computer and said communication terminal equipment according to said authenticating system; and
encrypting data destined for said communication terminal equipment according to said encrypting rule, transmitting said encrypted data through said wireless network, and decrypting said encrypted data received from said communication terminal equipment through said wireless network according to said decrypting rule.

16. A computer-readable recording medium on which is recorded a program on the side of a communication terminal equipment for communicating data through a wireless network, causing said computer to execute the process comprising the steps of:
obtaining an address of a gateway having a security capability through said wireless network, when said communication terminal equipment comes into a communicable area serviced by said wireless network;
communicating data with said gateway based on said obtained address, determining an authenticating system and an encrypting and a decrypting rules for data to be communicated, and giving an authentication between said gateway and said communication terminal equipment according to said authenticating system; and
encrypting data destined for another computer according to said encrypting rule, transmitting said encrypted data to said gateway through said wireless network, and decrypting said encrypted data received from said gateway through said wireless network according to said decrypting rule.
